(19) United States
(12) Patent Application Publication
(10) Pub. No.: US 2009/0255922 A1
(43) Pub. Date: Oct. 15, 2009

(54) SYSTEM AND METHOD FOR REDUCING CURRENT EXITING A ROLL THROUGH ITS BEARINGS USING BALANCED MAGNETIC FLUX VECTORS IN INDUCTION HEATING APPLICATIONS

(75) Inventors: Salvatore Chirico, Port Moody (CA); Nicholas Dohmeier, North Vancouver (CA)

Correspondence Address: Anthony Miologos;Honeywell International Inc., 101 Columbia Road, P.O. Box 2245, Morristown, NJ, 07962, US

(73) Assignee: Honeywell International Inc., Morristown, NJ (US)

(21) Appl. No.: 12/103,239

(22) Filed: Apr. 15, 2008

(51) Int. Cl. H05B 6/44; D21F 3/08; D21G 1/02

(52) U.S. Cl. 219/619; 219/672; 162/360.3; 162/121; 162/122

(57) ABSTRACT

A system includes a roll formed from a conductive material, where the roll is configured to rotate about an axis. The system also includes at least one induction heating workcoil configured to generate multiple magnetic fluxes within the roll. Each induction heating workcoil includes at least two separately wound coils. The multiple magnetic fluxes when spatially summed have a substantially null magnetic flux vector. An induction heating workcoil could represent a balanced induction heating workcoil that is configured to individually generate multiple magnetic fluxes that when spatially summed have the substantially null magnetic flux vector. Multiple induction heating workcoils could also represent unbalanced induction heating workcoils configured to collectively generate multiple magnetic fluxes that when spatially summed have the substantially null magnetic flux vector.

### CROSS-REFERENCE TO RELATED APPLICATIONS

This disclosure is related to the following U.S. patent applications, which are incorporated by reference:

Ser. No. ______ entitled “SYSTEM AND METHOD FOR REDUCING CURRENT EXITING A ROLL THROUGH ITS BEARINGS” filed on ______ [DOCKET NO. H0019078-0108]; and

Ser. No. ______ entitled “SYSTEM, APPARATUS, AND METHOD FOR INDUCTION HEATING USING FLUX-BALANCED INDUCTION HEATING WORKCOIL” filed on ______ [DOCKET NO. H0019526-0108].

### TECHNICAL FIELD

This disclosure relates generally to paper production systems and other systems using rolls. More specifically, this disclosure relates to a system and method for reducing current exiting a roll through its bearings using balanced magnetic flux vectors in induction heating applications.

### BACKGROUND

Paper production systems and other types of continuous web systems often include a number of large rotating rolls. For example, sets of counter-rotating rolls can be used in a paper production system to compress a paper sheet being formed. The amount of compression provided by the counter-rotating rolls is often controlled through the use of induction heating devices. The induction heating devices create currents in a roll, which heats the surface of the roll. The heat or lack thereof causes the roll to expand and contract, which controls the amount of compression applied to the paper sheet being formed.

### SUMMARY

This disclosure provides a system and method for reducing current exiting a roll through its bearings using balanced magnetic flux vectors in induction heating applications.

In a first embodiment, a system includes a roll formed from a conductive material, where the roll is configured to rotate about an axis. The system also includes at least one induction heating workcoil configured to generate multiple magnetic fluxes within the roll. Each induction heating workcoil includes at least two separately wound coils. The multiple magnetic fluxes when spatially summed have a substantially null instantaneous magnetic flux vector.

In particular embodiments, each induction heating workcoil further includes at least one core, where the at least two coils are wound around the at least one core. The multiple coils could be arranged in series, in parallel, or in series and parallel.

In other particular embodiments, the roll represents one of a set of counter-rotating rolls. The counter-rotating rolls are configured to compress a web of material. Also, at least one induction heating actuator includes the at least one induction heating workcoil and at least one power source coupled to the at least two coils. In addition, the system further includes a controller configured to control the at least one power source to control an amount of compression provided by at least a portion of the counter-rotating rolls.

In yet other particular embodiments, at least one induction heating workcoil is a balanced induction heating workcoil. The balanced induction heating workcoil is configured to individually generate multiple magnetic fluxes that when spatially summed have the substantially null instantaneous magnetic flux vector.

In still other particular embodiments, multiple induction heating workcoils are unbalanced induction heating workcoils. The unbalanced induction heating workcoils are configured to collectively generate multiple magnetic fluxes that when spatially summed have the substantially null instantaneous magnetic flux vector.

In additional particular embodiments, the roll further includes a shaft and bearings. Also, the at least one induction heating workcoil is configured to generate minimal currents that flow in a direction substantially parallel to the axis of the roll.

In a second embodiment, a system includes a roll formed from a conductive material, where the roll is configured to rotate about an axis. The system also includes at least one induction heating workcoil configured to generate multiple magnetic fluxes within the roll. Each induction heating workcoil includes at least two separately wound coils. The multiple magnetic fluxes substantially cancel each other to produce a substantially null instantaneous current vector in the roll.

In a third embodiment, a method includes placing at least one induction heating workcoil in proximity with a roll. The induction heating workcoil includes at least one core and at least two coils, and the roll is configured to rotate about an axis. The method also includes generating multiple magnetic fluxes within the roll. The multiple magnetic fluxes create currents that do not flow in a direction substantially parallel to the axis of the roll.

Other technical features may be readily apparent to one skilled in the art from the following figures, descriptions, and claims.

### BRIEF DESCRIPTION OF THE DRAWINGS

For a more complete understanding of this disclosure, reference is now made to the following description, taken in conjunction with the accompanying drawings, in which:

FIG. 1 illustrates an example paper production system according to this disclosure;

FIG. 2 illustrates an example orientation of induction heating workcoils with respect to a roll according to this disclosure;

FIGS. 3A through 4D illustrate example induction heating workcoils according to this disclosure;

FIG. 5 illustrates an example configuration of induction heating workcoils with respect to a roll according to this disclosure; and

FIG. 6 illustrates an example method for reducing current exiting a roll through its bearings by balancing magnetic flux vectors according to this disclosure.

### DETAILED DESCRIPTION

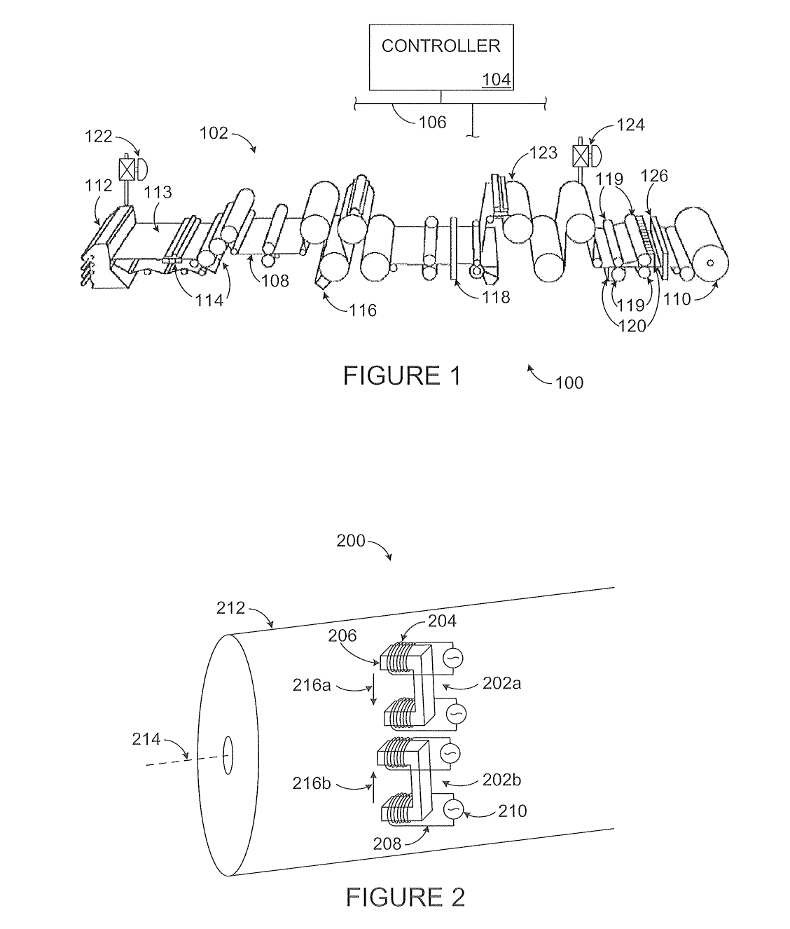

FIGS. 1 through 6, discussed below, and the various embodiments used to describe the principles of the present invention in this patent document are by way of illustration only and should not be construed in any way to limit the scope of the invention. Those skilled in the art will understand that the principles of the invention may be implemented in any type of suitably arranged device or system.

FIG. 1 illustrates an example paper production system 100 according to this disclosure. The embodiment of the paper production system 100 shown in FIG. 1 is for illustration only. Other embodiments of the paper production system 100 may be used without departing from the scope of this disclosure.

As shown in FIG. 1, the paper production system 100 includes a paper machine 102, a controller 104, and a network 106. The paper machine 102 includes various components used to produce a paper product. In this example, the various components may be used to produce a continuous paper web or sheet 108 collected at a reel 110. The controller 104 monitors and controls the operation of the system 100, which may help to maintain or increase the quality of the paper sheet 108 produced by the paper machine 102.

In this example, the paper machine 102 includes a headbox 112, which distributes a pulp suspension uniformly across the machine onto a continuous moving wire screen or mesh 113. The pulp suspension entering the headbox 112 may contain, for example, 0.2-3% wood fibers, fillers, and/or other materials, with the remainder of the suspension being water. The headbox 112 may include an array of dilution actuators, which distributes dilution water or a suspension of different composition into the pulp suspension across the sheet. The dilution water may be used to help ensure that the resulting paper sheet 108 has a more uniform basis weight or more uniform composition across the sheet 108. The headbox 112 may also include an array of slice lip actuators, which controls a slice opening across the machine from which the pulp suspension exits the headbox 112 onto the moving wire screen or mesh 113. The array of slice lip actuators may also be used to control the basis weight of the paper or the distribution of fiber orientation angles of the paper across the sheet 108.

An array of drainage elements 114, such as vacuum boxes, removes as much water as possible. An array of steam actuators 116 produces hot steam that penetrates the paper sheet 108 and releases the latent heat of the steam into the paper sheet 108, thereby increasing the temperature of the paper sheet 108 in sections across the sheet. The increase in temperature may allow for easier removal of additional water from the paper sheet 108. An array of rewet shower actuators 118 adds small droplets of water (which may be air atomized) onto one or both surfaces of the paper sheet 108. The array of rewet shower actuators 118 may be used to control the moisture profile of the paper sheet 108, reduce or prevent over-drying of the paper sheet 108, correct any dry streaks in the paper sheet 108, or enhance the effect of subsequent surface treatments (such as calendering).

The paper sheet 108 is then often passed through a calender having several nips of counter-rotating rolls 119. Arrays of induction heating workcoils 120 heat the surfaces of various ones of these rolls 119. As each roll surface locally heats up, the roll diameter is locally expanded and hence increases nip pressure, which in turn locally compresses the paper sheet 108 and transfers heat energy to it. The arrays of induction heating workcoils 120 may therefore be used to control the caliper (thickness) profile of the paper sheet 108. The nips of a calender may also be equipped with other actuator arrays, such as arrays of air showers or steam showers, which may be used to control the gloss profile or smoothness profile of the paper sheet.

Two additional actuators 122-124 are shown in FIG. 1. A thick stock flow actuator 122 controls the consistency of the incoming stock received at the headbox 112. A steam flow actuator 124 controls the amount of heat transferred to the paper sheet 108 from drying cylinders 123. The actuators 122-124 could, for example, represent valves controlling the flow of stock and steam, respectively. These actuators may be used for controlling the dry weight and moisture of the paper sheet 108. Additional components could be used to further process the paper sheet 108, such as a supercalender (for improving the paper sheet's thickness, smoothness, and gloss) or one or more coating stations (each applying a layer of coatant to a surface of the paper to improve the smoothness and printability of the paper sheet). Similarly, additional flow actuators may be used to control the proportions of different types of pulp and filler material in the thick stock and to control the amounts of various additives (such as retention aid or dyes) that are mixed into the stock.

This represents a brief description of one type of paper machine 102 that may be used to produce a paper product. Additional details regarding this type of paper machine 102 are well-known in the art and are not needed for an understanding of this disclosure. Also, this represents one specific type of paper machine 102 that may be used in the system 100. Other machines or devices could be used that include any other or additional components for producing a paper product. In addition, this disclosure is not limited to use with systems for producing paper sheets and could be used with systems that process the paper sheets or with systems that produce or process other products or materials in continuous webs (such as plastic sheets or thin metal films like aluminum foils).

In order to control the paper-making process, one or more properties of the paper sheet 108 may be continuously or repeatedly measured. The sheet properties can be measured at one or various stages in the manufacturing process. This information may then be used to adjust the paper machine 102, such as by adjusting various actuators within the paper machine 102. This may help to compensate for any variations of the sheet properties from desired targets, which may help to ensure the quality of the sheet 108.

As shown in FIG. 1, the paper machine 102 includes a scanner 126, which may include one or more sensors. The scanner 126 is capable of scanning the paper sheet 108 and measuring one or more characteristics of the paper sheet 108. For example, the scanner 126 could include sensors for measuring the weight, moisture, caliper (thickness), gloss, color, smoothness, or any other or additional characteristics of the paper sheet 108. The scanner 126 includes any suitable structure or structures for measuring or detecting one or more characteristics of the paper sheet 108, such as sets or arrays of sensors.

The controller 104 receives measurement data from the scanner 126 and uses the data to control the system 100. For example, the controller 104 may use the measurement data to adjust the various actuators in the paper machine 102 so that the paper sheet 108 has properties at or near desired properties. The controller 104 includes any hardware, software, firmware, or combination thereof for controlling the operation of at least part of the system 100. Also, while one controller is shown here, multiple controllers could be used to control the paper machine 102.

The network 106 is coupled to the controller 104 and various components of the system 100 (such as actuators and scanners). The network 106 facilitates communication between components of system 100. The network 106 represents any suitable network or combination of networks facilitating communication between components in the system 100. The network 106 could, for example, represent an Ethernet network, an electrical signal network (such as a HART or FOUNDATION FIELDBUS network), a pneumatic control signal network, or any other or additional network(s).

In one aspect of operation, the induction heating workcoils 120 may operate by generating currents in the surface of one or more of the rolls 119. In some conventional systems, the currents created in a roll can exit the roll through its bearings. These so-called “bearing currents” (also called “shaft currents”) can lead to premature wear and damage to the bearings supporting the roll. For example, the bearings can sometimes separate by small distances, and the currents flowing through the bearings can create sparks that pit or otherwise damage the bearings. Because of this, the bearings need to be replaced sooner or more often than desired. This leads to down time of the system 100 and monetary losses. While insulated bearings are available and could be used, the insulated bearings are often quite expensive compared to conventional bearings. In accordance with this disclosure, the induction heating workcoils 120 are designed or configured so that a reduced or minimal amount of current flows out of the rolls 119 through their bearings. This is done by balancing the magnetic fluxes created by the induction heating workcoils 120 within the rolls 119. This leads to reduced wear on and damage to the bearings, resulting in increased usage and fewer replacements. Additional details are provided below.

Although FIG. 1 illustrates one example of a paper production system 100, various changes may be made to FIG. 1. For example, other systems could be used to produce paper sheets or other products. Also, while shown as including a single paper machine 102 with various components and a single controller 104, the production system 100 could include any number of paper machines or other production machinery having any suitable structure, and the system 100 could include any number of controllers. In addition, FIG. 1 illustrates one operational environment in which induction heating workcoils 120 or other workcoils can be designed or configured to reduce currents flowing through bearings of one or more rolls using balanced magnetic flux vectors. This functionality could be used in any other suitable system.

FIG. 2 illustrates an example orientation 200 of induction heating workcoils with respect to a roll according to this disclosure. As shown in FIG. 2, two induction heating workcoils 202a-202b are positioned adjacent to each other. Each of the induction heating workcoils 202a-202b includes at least two separately wound coils 204 and at least one core 206. Each coil 204 generally represents any suitable conductive material(s) wound in a coil or otherwise wrapped around at least a portion of a core 206. Each coil 204 could, for example, represent Litz wire or other conductive wire wrapped around a core 206. Each core 206 generally represents a structure that can direct or focus a magnetic field created by current flowing through at least one coil 204. Each core 206 could, for example, represent ferrite. Terminal wires 208 couple each coil 204 to a power source 210. A combination of one or more workcoils and one or more power sources forms an induction heating actuator. Each power source 210 generally represents a source of electrical energy flowing through one or more of the coils 204. Each power source 210 could, for example, represent an alternating current (AC) source that operates at a specified frequency (such as 16 kHz or other frequency). The AC signals flow through the coils 204 and produce magnetic fluxes.

In this example, the induction heating workcoils 202a-202b are placed in proximity to a roll 212, which rotates about an axis 214. Magnetic fluxes 216a-216b are produced in the roll 212 by the induction heating workcoils 202a-202b and produce currents in the surface of the roll 212, heating the surface of the roll 212. The currents generally flow in a direction orthogonal (perpendicular) to the magnetic fluxes 216a-216b . The production of the currents can be adjusted to control the amount of heating of the roll's surface, which also controls the amount of compression applied by the roll 212 to a paper sheet or other product.

In some embodiments, the induction heating workcoils 202a-202b represent unbalanced workcoils, meaning each individual workcoil produces magnetic fluxes that have an appreciably non-null sum spatial vector. In these embodiments, multiple unbalanced workcoils can be oriented so that their magnetic fluxes effectively cancel each other out, producing a substantially zero sum spatial vector. In other embodiments, the induction heating workcoils 202a-202b represent balanced workcoils, meaning each individual workcoil creates magnetic fluxes that effectively cancel each other out to produce a substantially zero sum spatial vector. In either of these embodiments, the induction heating workcoils 202a-202b individually or collectively produce a substantially null instantaneous current vector, meaning little or no current flows parallel to the axis 214 and out of the roll 212 through its bearings at its ends. Of course, a combination of balanced and unbalanced induction heating workcoils could also be used. In general, any combination of induction heating workcoils can be used as long as the magnetic flux vectors produced in the roll 212 when spatially summed produce a substantially null instantaneous magnetic flux vector.

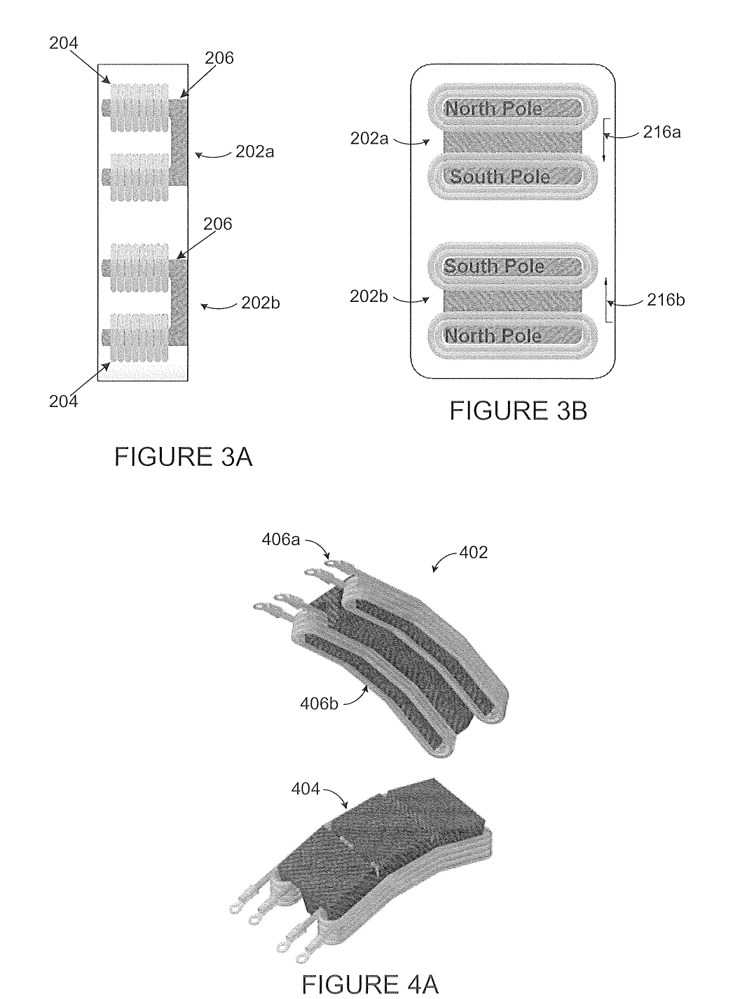

In the example shown in FIG. 2, the induction heating workcoils 202a-202b are unbalanced workcoils. This is shown more clearly in FIGS. 3A and 3B. As shown in FIG. 3A, the induction heating workcoils 202a-202b include open cores 206 that are U-shaped or C-shaped with opposing legs and a central portion connecting the legs. Also, the coils 204 are wound around the legs of the cores 206. It may be noted that one or multiple coils 204 could be wound around the core 206. If multiple coils 204 are used, the coils 204 could be arranged in series, in parallel, or in a series-parallel configuration.

As shown in FIG. 3B, the cores 206 are arranged geometrically so that, when the magnetic fluxes 216a-216b are spatially summed, a substantially null flux vector results. For instance, when the coils 204 of the induction heating workcoils 202a-202b are excited (by signals from the power sources 210), one leg of each workcoil becomes a magnetic north pole, and the other leg of each workcoil becomes a magnetic south pole. The magnetic fluxes 216a-216b are created in a direction from the north poles to the south poles. By arranging and exciting the workcoils 202a-202b so that the magnetic poles of the workcoils are opposite each other, the magnetic fluxes 216a-216b are also opposite each other, helping to spatially cancel the magnetic fluxes 216a-216b.

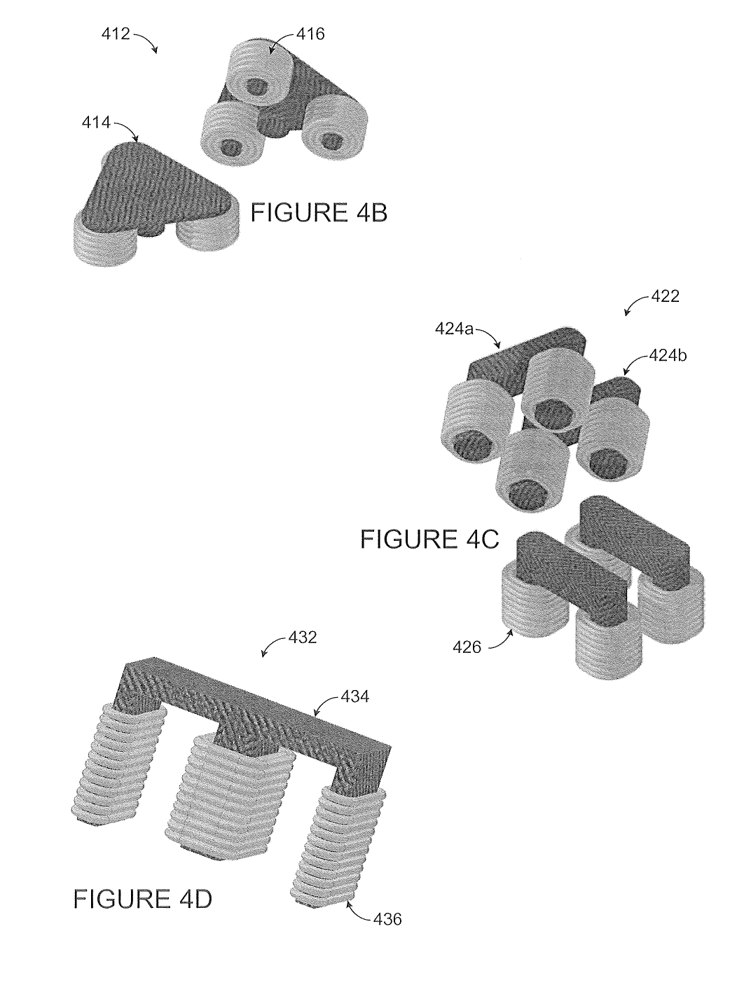

While the induction heating workcoils 202a-202b are shown here as having generally U-shaped or C-shaped cores with coils around legs of the cores, various other types of induction heating workcoils could be used. Examples of additional induction heating workcoils are shown in FIGS. 4A through 4D. In FIG. 4A, an induction heating workcoil 402 includes one or more connected E-shaped cores 404 and two or more coils 406a-406b separately wound lengthwise around each of the two outer legs of the cores 424. In FIG. 4B, an induction heating workcoil 412 includes a Y-shaped core 414 and one or more coils 416 separately wound around each of three outer legs arranged in a Y-configuration. In FIG. 4C, an induction heating workcoil 422 includes multiple cores 424a-424b in a parallel or H-configuration and one or more coils 426 wound separately around legs of the cores 424a-424b. In FIG. 4D, an induction heating workcoil 432 includes an E-shaped core 434 having three legs and one or more coils 436 wound around each leg of the core 434.

Any of these workcoils could be used with the roll 212 and arranged and oriented to produce substantially null spatial current vectors in the roll 212. Because of this, a reduced or minimal amount of current may flow parallel to the axis 214 of the roll 212. This can help to reduce or minimize bearing currents through the bearings of the roll 212.

Although FIG. 2 illustrate one example of an orientation 200 of induction heating workcoils with respect to a roll, various changes may be made to FIG. 2. For example, any suitable number of induction heating workcoils could be used with the roll 212. Although FIGS. 3A through 4D illustrate examples of induction heating workcoils, various changes may be made to FIGS. 3A through 4D. For instance, cores with any other suitable shape(s) and coils in any other suitable location(s) on the core(s) could be used. In general, any induction heating workcoils that can create a substantially null flux vector could be used here.

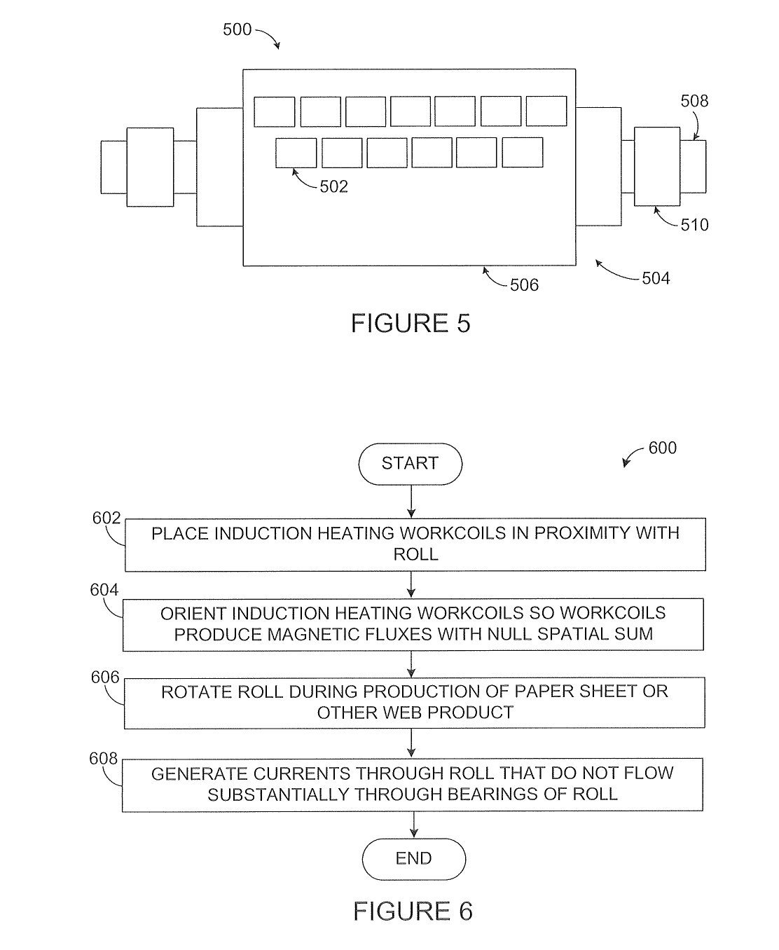

FIG. 5 illustrates an example configuration 500 of induction heating workcoils with respect to a roll according to this disclosure. As shown in FIG. 5, the configuration 500 includes multiple induction heating workcoils 502 placed adjacent to each other in an end-to-end fashion across the surface of a roll 504. The induction heating workcoils 502 could have any suitable spacing, such as one induction heating workcoil every fifty millimeters. The configuration 500 also includes multiple rows of induction heating workcoils 502. The induction heating workcoils 502 in the different rows may or may not be offset, and the rows could have any suitable spacing.

The induction heating workcoils 502 operate to produce currents in different areas or zones of a conductive shell 506 of the roll 504. The conductive shell 506 generally represents the portion of the roll 504 that contacts a paper sheet or other product being formed. The conductive shell 506 or the roll 504 could be formed from any suitable material(s), such as a metallic ferromagnetic material. The currents could also be produced in different areas or zones of the roll 504 itself, such as when the roll 504 is solid. The amount of current flowing through the zones could be controlled by adjusting the amount of energy flowing into the coils of the induction heating workcoils 502 (via control of the power sources 210). This control could, for example, be provided by the controller 104 in the paper production system 100 of FIG. 1.

In order to reduce or minimize currents flowing through a shaft 508 and through bearings in a bearing house 510 of the roll 504, the induction heating workcoils 502 represent (i) balanced workcoils that individually produce a substantially null flux vector and/or (ii) unbalanced workcoils that collectively produce a substantially null flux vector. As a result, a reduced or minimized amount of current flows through the bearings of the roll 504.

Although FIG. 5 illustrates one example of a configuration 500 of induction heating workcoils with respect to a roll, various changes may be made to FIG. 5. For example, the configuration 500 could include any number of rows of induction heating workcoils 502 at any uniform or non-uniform spacing. Also, each row could include any number of induction heating workcoils 502 at any uniform or non-uniform spacing.

FIG. 6 illustrates an example method 600 for reducing current exiting a roll through its bearings by balancing magnetic flux vectors according to this disclosure. As shown in FIG. 6, one or more induction heating workcoils are placed in proximity to a roll at step 602. This could include, for example, placing one or multiple induction heating workcoils 120 near a roll 119 in a paper calender. Any suitable number of induction heating workcoils could be placed near the roll, and the induction heating workcoils could have any suitable arrangement or configuration. In particular embodiments, balanced induction heating workcoils could be placed individually near the roll 119, while unbalanced induction heating workcoils could be placed in groups near the roll 119.

The induction heating workcoils are oriented at step 604. This could include, for example, orienting the induction heating workcoils so that magnetic fluxes produced by the induction heating workcoils have a substantially null spatial sum. Balanced induction heating workcoils could be oriented in any suitable manner since their magnetic fluxes may already have a substantially null spatial sum. Unbalanced induction heating workcoils may require more precise orientations to produce magnetic fluxes with a substantially null spatial sum.

Once installed and oriented, the roll can be rotated during the production of a paper sheet or other continuous web product at step 606, and currents are produced through the roll at step 608. The currents can be generated by providing AC signals to the coils 204 of the induction heating workcoils. Moreover, a reduced or minimized amount of current flows through the bearings of the roll because the induction heating workcoils produce magnetic fluxes with a substantially null spatial sum.

Although FIG. 6 illustrates one example of a method 600 for reducing current exiting a roll through its bearings by balancing magnetic flux vectors, various changes may be made to FIG. 6. For example, while shown as a series of steps, various steps shown in FIG. 6 could overlap, occur in parallel, occur in a different order, or occur multiple times.

It may be advantageous to set forth definitions of certain words and phrases used throughout this patent document. The term “couple” and its derivatives refer to any direct or indirect communication between two or more elements, whether or not those elements are in physical contact with one another. The terms “include” and “comprise,” as well as derivatives thereof, mean inclusion without limitation. The term “or” is inclusive, meaning and/or. The phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like. The term “controller” means any device, system, or part thereof that controls at least one operation. A controller may be implemented in hardware, firmware, software, or some combination of at least two of the same. The functionality associated with any particular controller may be centralized or distributed, whether locally or remotely.

While this disclosure has described certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure, as defined by the following claims.

What is claimed is:

1. A system comprising:
a roll comprising a conductive material, the roll configured to rotate about an axis; and
at least one induction heating workcoil configured to generate multiple magnetic fluxes within the roll, wherein each induction heating workcoil comprises at least two separately wound coils, and wherein the multiple magnetic fluxes when spatially summed have a substantially null instantaneous magnetic flux vector.

2. The system of claim 1, wherein each induction heating workcoil further comprises at least one core, the at least two coils separately wound around the at least one core.

3. The system of claim 2, wherein the at least two coils are arranged in series, in parallel, or in series and parallel.

4. The system of claim 2, wherein the roll comprises one of a set of counter-rotating rolls, the counter-rotating rolls configured to compress a web of material.

5. The system of claim 4, wherein:
at least one induction heating actuator comprises the at least one induction heating workcoil and at least one power source coupled to the at least two coils; and
the system further comprises a controller configured to control the at least one power source to control an amount of compression provided by at least a portion of the counter-rotating rolls.

6. The system of claim 1, wherein at least one induction heating workcoil is a balanced induction heating workcoil, the balanced induction heating workcoil configured to individually generate multiple magnetic fluxes that when spatially summed have the substantially null instantaneous magnetic flux vector.

7. The system of claim 1, wherein multiple induction heating workcoils are unbalanced induction heating workcoils, the unbalanced induction heating workcoils configured to collectively generate multiple magnetic fluxes that when spatially summed have the substantially null instantaneous magnetic flux vector.

8. The system of claim 1, wherein:
the roll further comprises a shaft and bearings; and
the at least one induction heating workcoil is configured to generate minimal currents that flow in a direction substantially parallel to the axis of the roll.

9. A system comprising:
a roll comprising a conductive material, the roll configured to rotate about an axis; and
at least one induction heating workcoil configured to generate multiple magnetic fluxes within the roll, wherein each induction heating workcoil comprises at least two separately wound coils, and wherein the multiple magnetic fluxes substantially cancel each other to produce a substantially null instantaneous current vector substantially parallel to the axis of the roll.

10. The system of claim 9, wherein each induction heating workcoil further comprises at least one core, the at least two coils separately wound around the at least one core.

11. The system of claim 10, wherein the at least two coils are arranged in series, in parallel, or in series and parallel.

12. The system of claim 10, wherein the roll comprises one of a set of counter-rotating rolls, the counter-rotating rolls configured to compress a web of material.

13. The system of claim 12, wherein:
at least one induction heating actuator comprises the at least one induction heating workcoil and at least one power source coupled to the at least two coils; and
the system further comprises a controller configured to control the at least one power source to control an amount of compression provided by at least a portion of the counter-rotating rolls.

14. The system of claim 9, wherein at least one induction heating workcoil is a balanced induction heating workcoil, the balanced induction heating workcoil configured to individually generate multiple magnetic fluxes that substantially cancel each other to produce the substantially null instantaneous current vector.

15. The system of claim 9, wherein multiple induction heating workcoils are unbalanced induction heating workcoils, the unbalanced induction heating workcoils configured to collectively generate multiple magnetic fluxes that substantially cancel each other to produce the substantially null instantaneous current vector.

16. The system of claim 9, wherein:
the roll further comprises a shaft and bearings; and
the at least one induction heating workcoil is configured to generate minimal currents that flow in a direction substantially parallel to the axis of the roll.

17. A method comprising:
placing at least one induction heating workcoil in proximity with a roll, wherein the induction heating workcoil comprises at least one core and at least two coils, wherein the roll is configured to rotate about an axis; and
generating multiple magnetic fluxes within the roll, the multiple magnetic fluxes creating currents that do not flow in a direction substantially parallel to the axis of the roll.

18. The method of claim 17, wherein the multiple magnetic fluxes when spatially summed have a substantially null instantaneous magnetic flux vector.

19. The method of claim 18, wherein at least one induction heating workcoil is a balanced induction heating workcoil, the balanced induction heating workcoil individually generating multiple magnetic fluxes that when spatially summed have the substantially null magnetic flux vector.

20. The method of claim 17, wherein:
the roll comprises one of a set of counter-rotating rolls, the counter-rotating rolls configured to compress a web of material;
at least one induction heating actuator comprises the at least one induction heating workcoil and at least one power source coupled to the at least two coils; and
further comprising controlling the at least one power source to control an amount of compression provided by at least a portion of the counter-rotating rolls.
